(19) United States
(12) Patent Application Publication
(10) Pub. No.: US 2010/0130369 A1
(43) Pub. Date: May 27, 2010

(54) Bead-Based Multiplexed Analytical Methods and Instrumentation

(75) Inventors: Alexander Shenderov, Raleigh, NC (US); Richard Kouri, Raleigh, NC (US); Varvara Grichko, Irvine, CA (US)

Correspondence Address: ADVANCED LIQUID LOGIC, INC.;C/O WARD AND SMITH, P.A., 1001 COLLEGE COURT, P.O. BOX 867, NEW BERN, NC, 28563-0867, US

(73) Assignee: ADVANCED LIQUID LOGIC, INC., Research Triangle Park, NC (US)

(21) Appl. No.: 12/596,897

(22) PCT Filed: Mar. 24, 2008
(86) PCT No.: PCT/US08/58018

§ 371 Date: Oct. 21, 2009

Related U.S. Application Data
(60) Provisional application No. 60/913,416, filed on Apr. 23, 2007.

(51) Int. Cl. C40B 30/00; C40B 50/08

(52) U.S. Cl. 506/7; 506/27

(57) ABSTRACT

Various methods, such as a method of detecting SNPs, involving (a) introducing onto a droplet actuator a solution comprising genomic DNA, extension oligos and suspension array beads; (b) dispensing on the droplet actuator one bead per droplet; (c) cleaving DNA from the bead in each droplet; (d) amplifying the cleaved DNA; (e) detecting SNP signals and barcode signals from the amplified DNA.

### RELATED APPLICATION

This application claims priority to U.S. patent application Ser. No. 60/913,416, filed on Apr. 23, 2007, entitled Bead-Based Multiplexed Analytical Methods and Instrumentation, the entire disclosure of which is incorporated herein by reference.

### BACKGROUND

Droplet microactuators are used to conduct a wide variety of droplet operations. A droplet microactuator typically includes two substrates separated by a space. The substrates include electrodes for conducting droplet operations. The space is typically filled with a filler fluid that is immiscible with the fluid that is to be manipulated on the droplet microactuator. Surfaces exposed to the space are typically hydrophobic. There is a need in the art for methods of preparing samples for analysis, such as analysis of genetic material (genomics) and its expression (functional genomics), proteomics, combinatorial library analysis, and other multiplexed bioanalytical applications.

### DEFINITIONS

As used herein, the following terms have the meanings indicated.

“Activate” with reference to one or more electrodes means effecting a change in the electrical state of the one or more electrodes which results in a droplet operation.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical and other three dimensional shapes. The bead may, for example, be capable of being transported in a droplet on a droplet actuator; configured with respect to a droplet actuator in a manner which permits a droplet on the droplet actuator to be brought into contact with the bead, on the droplet actuator and/or off the droplet actuator. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead or one component only of a bead. The remainder of the bead may include, among other things, polymeric material, coatings, and moieties which permit attachment of an assay reagent. Examples of suitable magnetically responsive beads are described in U.S. Patent Publication No. 2005-0260686, entitled, “Multiplex flow assays preferably with magnetic particles as solid phase,” published on Nov. 24, 2005, the entire disclosure of which is incorporated herein by reference for its teaching concerning magnetically responsive materials and beads.

“Droplet” means a volume of liquid on a droplet actuator which is at least partially bounded by filler fluid. For example, a droplet may be completely surrounded by filler fluid or may be bounded by filler fluid and one or more surfaces of the droplet actuator. Droplets may take a wide variety of shapes; nonlimiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more surfaces of a droplet actuator.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to size of the resulting droplets (i.e., the size of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading.

“Immobilize” with respect to magnetically responsive beads, means that the beads are substantially restrained in position in a droplet or in filler fluid on a droplet actuator. For example, in one embodiment, immobilized beads are sufficiently restrained in position to permit execution of a spiltting operation on a droplet, yielding one droplet with substantially all of the beads and one droplet substantially lacking in the beads.

“Magnetically responsive” means responsive to a magnetic field. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

The terms “top” and “bottom” are used throughout the description with reference to the top and bottom substrates of the droplet actuator for convenience only, since the droplet actuator is functional regardless of its position in space.

When a given component such as a layer, region or substrate is referred to herein as being disposed or formed “on” another component, that given component can be directly on the other component or, alternatively, intervening components (for example, one or more coatings, layers, interlayers, electrodes or contacts) can also be present. It will be further understood that the terms “disposed on” and “formed on” are used interchangeably to describe how a given component is positioned or situated in relation to another component. Hence, the terms “disposed on” and “formed on” are not intended to introduce any limitations relating to particular methods of material transport, deposition, or fabrication.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct droplet operations on the droplet, the droplet is arranged on the droplet actuator in a manner which facilitates sensing of a property of or a signal from the droplet, and/or the droplet has been subjected to a droplet operation on the droplet actuator.

### DESCRIPTION

The multiplexed analytical methods discussed here are based on attaching a selective probe to beads coded so that each type of selective probe is associated with a unique, identifiable code; conducting a single-tube assay. With a single-tube assay, a plurality of beads may be brought into contact (e.g., simultaneously or near-simultaneously), for a predetermined period of time, with the sample to be analyzed; optionally, washed to remove unbound and/or unreacted sample; and analyzed, (each bead individually), with or without pooling, for both the amount of analyte bound to the selective probe and for the code uniquely identifying that probe.

The disclosed methods are employ bead coding in which with identifiable molecules (labels) are coupled to the surface of the beads, preferably in a manner allowing controlled release of those molecules from the bead surface (for example, hydrolytic cleavage). In addition, those identifiable molecules may permit chemical amplification, such as DNA (amplifiable by PCR or RCA). The interpretation of the code is binary, meaning that presence or absence of a specific identifiable molecule on the surface of a particular bead constitutes a “1” or a “0,” respectively, in that bead's code in the position coded by that particular identifiable molecule (i.e., the specific molecule is either present or absent). This approach allows coding for 2N different types of beads (i.e., different specific probes) with N types of labels. Preferably, the identifiable molecules comprise different DNA sequences.

Some or all of the identifiable molecules can be chemically linked; for example, the DNA sequences representing the code may be parts of a linear or branched DNA molecule coupled to the bead.

The code readout can be based on any of the methods known in the art, applied sequentially or in parallel, to detect each of the identifiable molecules separately. In particular, if labels are represented by DNA sequences, detection can be accomplished with molecular beacons containing sequences complementary to the labels (one molecular beacon per label). The code of an individual bead is read after the bead has been isolated in an individual droplet by a method known in the art, such as ink-jet dispensing, ultrasonic atomization, or electrowetting dispensing. See M. G. Pollack, R. B. Fair, and A. D. Shenderov, Appl.Physiett., 77 (11), 1725 (2000); U.S. patent application Ser. No. 09/490,769, filed 24 Jan. 2000; and U.S. patent Application entitled “Electrostatic actuators for microfluidics and methods for using same,” filed 30 Aug. 2001 (collectively, the Shenderov patent applications). The contents of each of these are incorporated by reference herein in their entireties.

In a preferred embodiment, after the single-bead droplets have been formed, code sequences are separated from the bead surface and dispensed into an appropriate number of secondary droplets. Subsequently, the secondary droplets are used to detect labels (one label per droplet or a plurality of labels in a droplet) by known methods, such as (in case of DNA labels) admixing appropriate molecular beacons and detecting fluorescence (multicolored if a plurality of labels are detected in the same droplet). Optionally, the readout signal from each label can be amplified by any known method, such as PCR or RCA for DNA labels, or ELISA for antigen labels. The readout from the analyte bound to, or chemically reacted with, the bead surface is also obtained by any of the known methods, such as fluorescence for fluorescence-labeled samples. Subsequently, the code is combined with analyte data to annotate it and identify the analyte.

One instrument that can be employed to perform the method is a preparative workstation where aliquots of bead suspensions are recombined with combinations of labels constituting a code for a particular probe, as well as the probe itself, and (optionally) incubated for such a time and under such conditions as to provide for attachment of labels and probes to the bead surface. Another such instrument is an analytical workstation including: a dispenser for making single-bead droplets, an (optional) droplet sorter for handling beads containing no beads or more than one bead, units for conducting cleavage and optional amplification, and a detector for reading the analyte signal and the code. The analytical workstation also includes software for combining the readout signals into annotated data, while the preparative workstation includes software for generating the annotation tables of correspondence between the codes and the nature of associated probes. The workstations are preferably based on electrowetting microfluidics, as described in Pollack et al., supra, and the Shenderov patent applications.

### 4.1 Genomics Application (SNP Analysis)

There is a consensus that genomics is likely to play an increasingly important role in drug discovery and development, as well as in medicine. While there are some unsolved ethical questions surrounding the use of an individual's genetic code to determine her/his disease susceptibility, there is little argument against using this information for optimizing treatment. Targeting drugs to patients most likely to respond to them, and least likely to develop unwanted side effects, will become the driving force of competition in the pharmaceutical industry. That trend has already dramatically increased the demand for pharmacogenomic information on genotypes associated with differential drug responses. The challenge here is to identify a comprehensive set of polymorphic sites in the human genome for each disease that is relevant to a particular clinical situation. While the set itself may contain only a few sites, identifying it requires genome-wide scanning methods applied to many patients in clinical studies. At present, costs are relatively high and throughput of analysis is often low for widespread use of this approach. As such, new technologies are urgently needed in this field.

Functional genomics studies control of expression of genes in various tissues as a function of, for example, developmental stage, disease, nutrition, action of drugs, and exposure to radiation. Methods of functional genomics include quantitative conversion of expressed genes (RNA back to DNA), quantitative amplification of the resultant DNA (cDNA, for complementary DNA), and selective detection of each DNA sequence. Determining the abundance of cDNA corresponding to each gene provides information on control of the gene's expression. Functional genomics is used in pharmacology and medicine for studying mechanisms of disease and healing, drug response, and side effects, as well as for diagnostic purposes.

Similarly, genomics and functional genomics also play an increasing role in agriculture (including discovery of new crop protection agents, genetic engineering of plants and animals) as well as in veterinary medicine. In particular, better understanding of expression of new genes in the host genomes will help manage the (real and perceived) risks of genetically engineered food.

The following description of one embodiment of the method, according to the invention, is for the particular case of single nucleotide polymorphisms (SNP) genotyping. Changes to the analysis protocol immediately apparent to those skilled in the art allow alternative uses for the invention in genomics, functional genomics, and other bioanalytical applications. Brief descriptions of such altered protocols are also provided below.

The number of SNP readings necessary to identify clinically relevant information can be staggering, requiring a robust, inexpensive method of multiplexed high-throughput SNP analysis, allowing minimally invasive sample collection from the patients and maximum information output. Therefore, it has become very important to make SNP genotyping a routine protocol. Currently, the cost is typically high, which is one obstacle to individualized medicine of the future.

Of the many methods of SNP genotyping tested to date, bead-based genotyping is one of the most promising (see Shi MM, Enabled large-scale pharmacogenetic studies by high-throughput mutation detection and genotyping technologies. Clin. Chem. 47: 164172 (2001)). A very high degree of multiplexing and throughput can potentially be achieved using an extremely small sample. Nevertheless, the currently available bead-based SNP genotyping technologies generally have limited multiplexing capability. First, in their current implementation, they require multiplexed amplification of genomic DNA. An even more severe restriction on multiplexing is due to the mode of bead identification currently employed. For example, in some instances, the beads are color-coded with two fluorescent dyes; dye content is determined in the flow cytometer simultaneously with reading the SNP. Ordinarily, no more than 100 different types of beads can be distinguished by this method, limiting the multiplexing to 100 SNPs per reaction (as described by Luminex, Inc.)

A method, such as that of the present invention, that separates individual beads into nanoliter volumes after a single-tube reaction with genomic DNA can enable the use of an alternative bead labeling and identification scheme, with a potential to read at least a million SNPs out of a single-tube reaction. Moreover, it can also allow performing amplification reactions, if necessary, on individual sequences rather than total genomic DNA. Ultimately, such technology can also allow parallel detection, thereby increasing detection times while improving sensitivity and potentially rendering the amplification step unnecessary altogether.

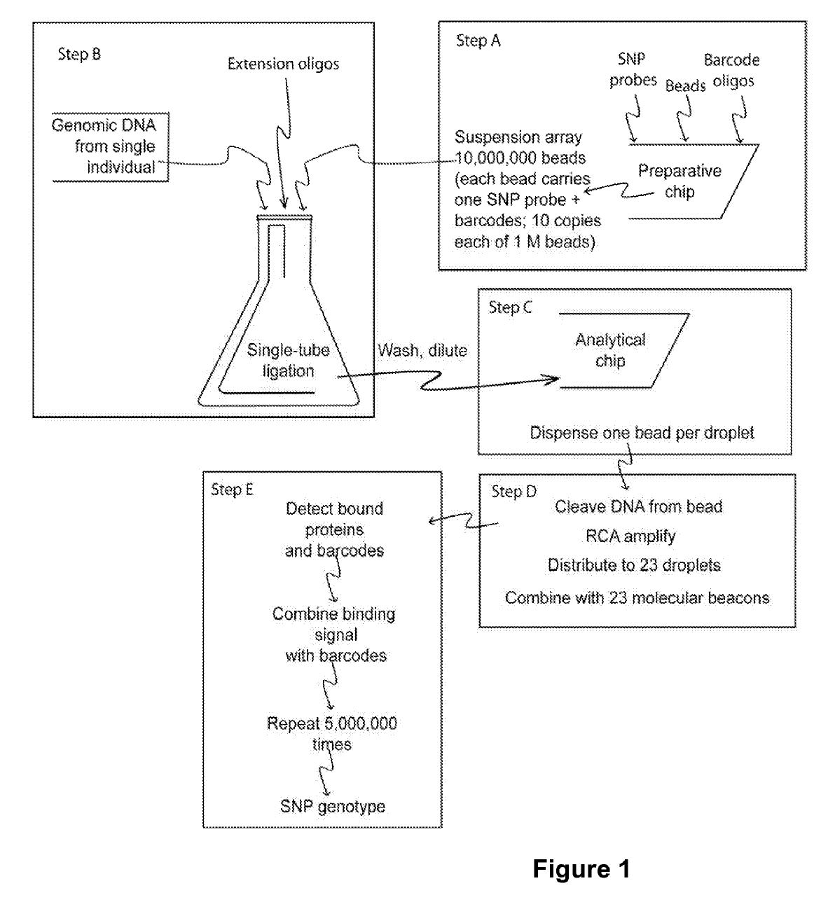

A flow chart depicting the disclosed SNP analysis system is shown in FIG. 1. The illustrated steps include: (a) creation of suspension arrays on a preparative droplet microactuator; (b) creation of SNP genotypes in a single-tube reaction; (c) arraying individual SNP-beads on an analysis droplet microactuator; (d) preparing individual beads for SNP identification and barcode reading; and (e) detecting the SNP signals and the barcode signals. These steps are discussed in greater detail below.

### 4.1.1 Creation of Suspension Arrays on Preparative Droplet Microactuator

The preparative droplet microactuator (Step (a) in FIG. 1) performs the following functions: dispensing bead suspension into an array of droplets; dispensing solutions of barcode sequences and recombining those into barcodes; dispensing droplets of probe solutions and binding reagents; combining barcodes, probes, beads, and binding reagents and performing the binding reaction; stopping the reaction and recombining the suspension array. The preparative droplet microactuator can be of the configuration discussed in the Shenderov patent applications, supra, to enable the steps of the assay to be carried out rapidly and automatically in nanoliter quantities.

In this embodiment, “barcode” oligonucleotides are designed to contain five functional components: (1) a 5′ amine modification (for amide coupling to the carboxylated microsphere), (2) a 15-18 carbon spacer that extends the oligonucleotide from the microsphere to reduce the effect of any charge interactions and steric hindrance, (3) a site for enzymatic cleavage, (4) a 10-13 by sequence for rolling circle amplification (RCA), and (5) a 15 by barcode sequence. The barcodes may be a set of 21 oligos that contain sequences that are as dissimilar as possible from each other and from human sequences as determined by BLAST analysis. Attachment of these barcode oligos to beads is done using, for example, the procedure described in Iannone M A, et al., Multiplexed single nucleotide polymorphism genotyping by oligonucleotide ligation and flow cytometry. Cytometry 39: 131-140 (2000). RCA is a preferred amplification method because of its prolific multiplexing capability, operation without thermal cycling, and linear kinetics, which exceed the number of copies of each temsubstrate that can be obtained by PCR in the first several minutes of reaction.

The SNP probes have similar functional components to the barcode oligonucleotides mentioned above. The SNP probe will have the 5′ amine modification, the carbon spacer, a site for enzymatic cleavage, a 10-13-bp sequence for RCA, and a 2025-bp sequence complementary to the sequence adjacent to a specific SNP. The lengths of the probe (and also the extension oligo, described in section 4.2) are adjusted so that their complexes with the SNP containing genome sequences all have similar Tₘ's. These SNP probes are coupled to the beads using, for example, the procedure of Iannone et al., supra.

The chemistry of DNA probes and barcodes can be altered by those skilled in the art within the scope of the present invention. For example, alternative attachment chemistry, spacer length and/or chemical nature, method of DNA amplification, and other elements can be used; some of those, such as cleavage site or the spacer, can be omitted altogether in some embodiments. Also, different numbers of oligonucleotides comprising the barcodes can be employed, depending on the extent and type of analysis to be performed.

### 4.1.2 Creation of SNP Genotypes in a Single Tube

The reagents employed in the performance of Step (B) are the suspension array created as described in section 2.1 above, genomic DNA sheared to relatively small fragments (approximately 300 bp), and extension oligonucleotides complementary to the DNA adjacent to the SNPs to be assayed. For reading up to 1 million different SNPs, a suspension array includes approximately 10 M beads, wherein each bead carries one SNP probe and a unique barcode, and there are (on average) 10 copies of each bead. An allele-specific ligation procedure is done, for example, as described by Samiotaki M. et al. Dual-color detection of DNA sequence variants by ligase-mediated analysis. Genomics 20: 238-242 (1994) as modified by Iannone et al., supra.

### 4.1.3 Analysis Droplet Microactuator

All of the following operations can be carried out on the analysis droplet microactuator: dispensing bead suspension into an array of droplets; identifying droplets containing single beads and processing others according to their content (discarding or splitting); cleaving labels and modified probes from the bead surface; amplifying by RCA (optional); distributing and combining droplets containing amplified sequences from a single bead with a set of molecular beacons; and detecting labels and analytes using an off- droplet microactuator reader (preferably by fluorescence). As is the case with the preparative droplet microactuator operations, the droplet operations can be carried out on a droplet microactuator of the configuration discussed in the Section 4.4.

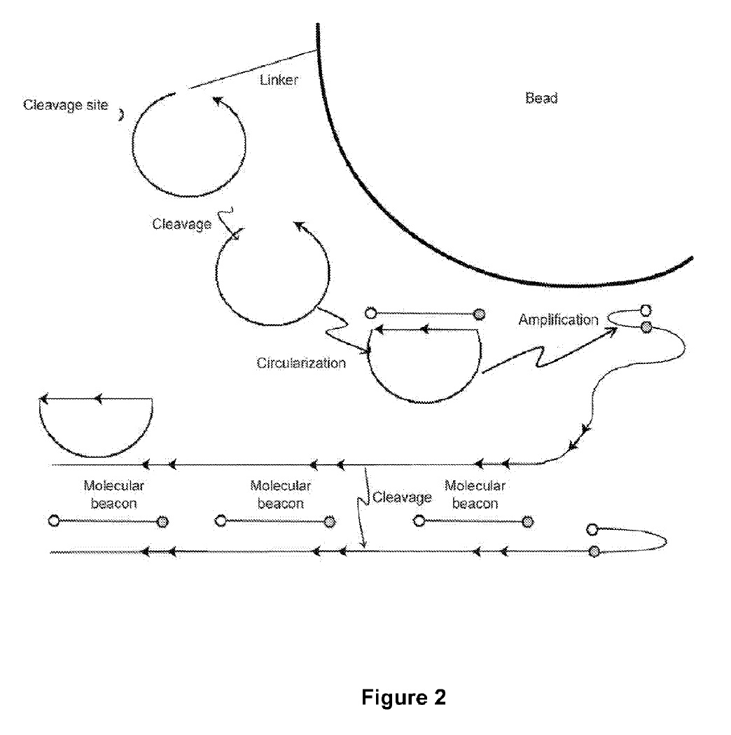

Identification of single, bead-containing droplets is preferably based on light scattering by the bead or its fluorescence. Dispensing bead suspension is preferably multiplexed. To cleave labels and modified probes, bead-containing droplets are merged with enzyme-containing droplets. Amplification is preferably by RCA, as described by AP Biotech (Piscataway, N.J.). The distribution of oligos for detection can be performed by diluting the test droplet to an appropriate volume and redispensing the volume into 23 secondary droplets. (This number may differ for different numbers of barcode oligonucleotides.) Each of the 23 droplets is merged with droplets containing one of 23 different sequences complementary to the barcode oligos. These complementary sequences are labeled with molecular beacons and detected by the tatters' fluorescence. FIG. 2 provides a diagram demonstrating this amplification and detection scheme.

### 4.2 Proteomics Application (Multiplexed Protein Analysis)

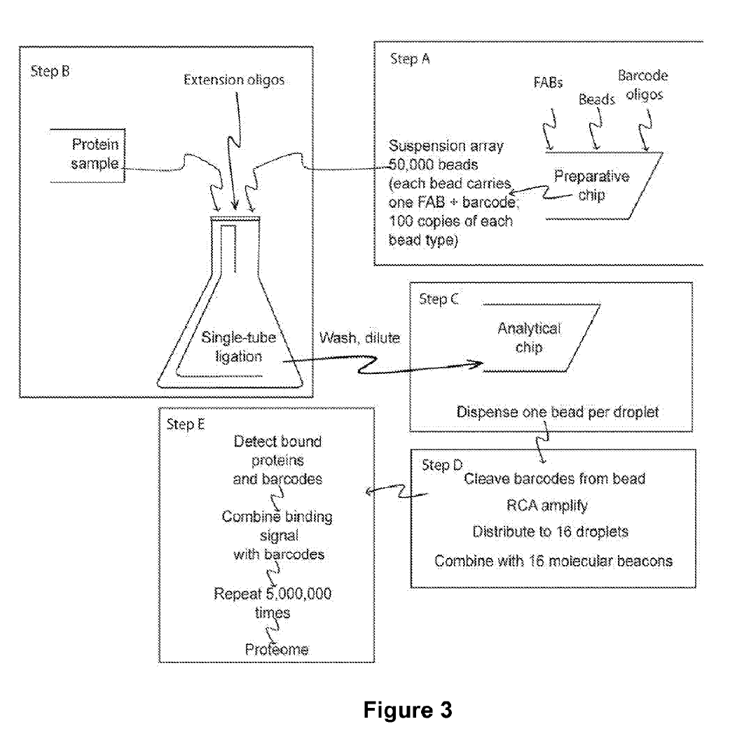

Another embodiment of the present invention is shown in FIG. 3. Essentially, the same scheme can be employed as that described above for SNP analysis. The only modification is that instead of DNA probes, the beads in the suspension array carry antibodies or other affinity probes (see Immobilized Bioniolecules in Analysis. A Practical Approach. Cass T, Ligler F S, eds. Oxford University Press, New York, 1998. pp 1-14 for typical attachment protocols). Suspension array construction, single-tube reaction, bead dispensing, and barcode reading can proceed in the same manner as described above for SNPs. The bound proteins are detected either by their own fluorescence (if the sample is labeled with a fluorescent dye), or with chemilumenescence or similar scheme (with alternative labeling chemistry). Chemiluminescence is the preferred method when sensitivity is a concern, as it allows for chemical amplification of the signal.

### 4.3 Coded Combinatorial Libraries

Combinatorial libraries of various compounds are useful in drug research, in particular for identifying new drug candidates by screening the libraries for compounds producing a detectable effect. Such an effect could, for example, be binding to a specific molecule or prevention/enhancement of formation of a complex of specific molecules, modifying (increasing or decreasing) the rate of a specific enzymatic reaction, induction of specific changes at the cellular level (initiation or arrest of cell cycle, production, and/or secretion of specific molecules), and the like. A library of compounds bound to a set of coded beads (constructed as described above) can be used in a variety of assays (for example, binding assays) wherein, after a single-tube reaction or another step involving pooling, there is a need to determine the identity of active compounds.

Although the barcoding technique described above is preferred for use with the present invention, other barcoding techniques may also be employed. For example, submicrometer metallic barcodes (described in Nicewarner-Pena S R, Freeman R G, Reiss B D, He L, Pena D J, Walton I D, Cromer R, Keating C D, Natan M J, Submicrometer metallic barcodes, Science 2001 October 5;294 (5540):137-41, and available from SurroMed, Inc., Mountain View, Calif.) utilizing metal microrods in place of beads can be employed. In this technique, patterns of stripes on the microrods are optically read to identify the constituents of the reaction in question. Another technique is the use of “quantum dots” (available from Quantum Dot Corporation, Hayward, Calif.), which can be optically scanned to identify the reaction. See Han M, Gao X, Su J Z, Nie S., Quantum-dot-tagged microbeads for multiplexed optical coding of biomolecules, Nat Biotechnol, 2001 July;19(7):631-5. These techniques involve the direct reading of the code from the microrod or particle, rather than the indirect determination of the DNA barcode described above that may provide more versatility to the process.

The foregoing examples are illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. All droplet manipulations described herein can be performed using droplet operations on a droplet microactuator.

### 4.4 Droplet Actuator

For examples of droplet actuator architectures suitable for use with the present invention, see U.S. Pat. No. 6,911,132, entitled “Apparatus for Manipulating Droplets by Electrowetting-Based Techniques,” issued on Jun. 28, 2005 to Pamula et al.; U.S. patent application Ser. No. 11/343,284, entitled “Apparatuses and Methods for Manipulating Droplets on a Printed Circuit Board,” filed on filed on Jan. 30, 2006; U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000, both to Shenderov et al.; Pollack et al., International Patent Application No. PCT/US 06/47486, entitled “Droplet-Based Biochemistry,” filed on Dec. 11, 2006, the disclosures of which are incorporated herein by reference. Examples of droplet actuator techniques for immobilizing magnetic beads and/or non-magnetic beads are described in the foregoing international patent applications and in Sista, et al., U.S. patent application Ser. Nos. 60/900,653, filed on Feb. 9, 2007, entitled “Immobilization of magnetically-responsive beads during droplet operations”; Sista et al., U.S. patent application Ser. No. 60/969,736, filed on Sep. 4, 2007, entitled “Droplet Actuator Assay Improvements”; and Allen et al., U.S. patent application Ser. No. 60/957,717, filed on Aug. 24, 2007, entitled “Bead washing using physical barriers,” the entire disclosures of which is incorporated herein by reference.

### 4.5 Fluids

For examples of fluids usefully processed according to the approach of the invention, see the patents listed in section 4.4, especially International Patent Application No. PCT/US 06/47486, entitled “Droplet-Based Biochemistry,” filed on Dec. 11, 2006. In some embodiments, the input fluid includes or consists of a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, fluidized tissues, fluidized organisms, biological swabs and biological washes.

### 4.6 Filler Fluids

The gap will typically be filled with a filler fluid. The filler fluid may, for example, be a low-viscosity oil, such as silicone oil. Other examples of filler fluids are provided in International Patent Application No. PCT/US 06/47486, entitled “Droplet-Based Biochemistry,” filed on Dec. 11, 2006.

This specification is divided into sections for the convenience of the reader only. Headings should not be construed as limiting of the scope of the invention.

It will be understood that various details of the present invention may be changed without departing from the scope of the present invention. Various aspects of each embodiment described here may be interchanged with various aspects of other embodiments. Furthermore, the foregoing description is for the purpose of illustration only, and not for the purpose of limitation.

We claim:

1. A method of detecting SNPs, the method comprising:
(a) introducing onto a droplet actuator a solution comprising genomic DNA, extension oligos and suspension array beads;
(b) dispensing on the droplet actuator one bead per droplet;
(c) cleaving DNA from the bead in each droplet;
(d) amplifying the cleaved DNA;
(e) detecting SNP signals and barcode signals from the amplified DNA.

2. A method of detecting the SNP signals and barcode signals, the method comprising:
(a) preparing suspension arrays on a preparative droplet microactuator;
(b) preparing genomic DNA in a single-tube reaction using beads from the suspension arrays;
(c) arraying individual SNP-beads on a second droplet microactuator;
(d) preparing individual beads for SNP identification and barcode reading on the second droplet actuator; and
(e) detecting SNP signals and barcode signals on the second droplet actuator.

3. A method of preparing a suspension array, the method comprising:
(a) introducing a bead suspension onto a droplet microctuator;
(b) dispensing on the droplet actuator:
(i) the bead suspension into an array of droplets;
(ii) droplets comprising barcode sequences;
(iii) droplets comprising probes and binding reagents;
(c) combining the droplets dispensed in (a) and performing the binding reaction;
(d) recombining the suspension array.

4. The method of claim 3 wherein one or more of the dispensing, combining, and recombining steps is conducted using droplet operations.
